(19) United States
(12) Patent Application Publication
(10) Pub. No.: US 2016/0103441 A1
(43) Pub. Date: Apr. 14, 2016

(54) MONITORING SYSTEM FOR MULTIPLE UTILITIES

(71) Applicant: Jason Henry DeVries, San Luis Obispo, CA (US)

(72) Inventor: Jason Henry DeVries, San Luis Obispo, CA (US)

(21) Appl. No.: 14/882,026

(22) Filed: Oct. 13, 2015

Related U.S. Application Data
(60) Provisional application No. 62/062,671, filed on Oct. 10, 2014.

(51) Int. Cl. G05B 19/05; G05B 19/042

(52) U.S. Cl. CPC G05B 19/05; G05B 19/0428; G05B 2219/14116

(57) ABSTRACT

A utility monitoring system is described that essentially provides a first sensor in-line in a first utility in a first structure, such as a house, and a second utility in the structure. A control hub communicatively linked to a central communications server, the sensors in the structure and a first switch consisting of on/off capability adapted to turn on or off the first utility and a second switch consisting of on/off capability adapted to turn on or off the second utility. The control hub able to receive on/off instructions from the central communication server to turn on or off the switches to the utilities based on information received either instantaneously from the sensors or over time from the sensors. The central communication server capable of connecting to a plurality of control hubs communicatively linked with additional sensors and on/off switches.

### CROSS-REFERENCE TO RELATED APPLICATIONS

This application claims priority to and the benefit of U.S. Provisional Patent Application No. 62/062,671 entitled: Monitoring System for Multiple Utility, filed on Oct. 10, 2014, the entire disclosure of which is hereby incorporated by reference.

### FIELD OF THE INVENTION

The present invention is directed to a monitoring multiple utilities in a home or business that is useful in providing emergency shutdown of one or more of the utilities in the home or business.

### BACKGROUND OF THE INVENTION

Presently, utilities are monitored and controlled in the home and business by way of user interface controllers that adjust and fine tune their operation. One example is the use of thermostats which are generally used to raise and lower temperature in a room by several degrees. Another example is water which is turned on or off or somewhere in between by a homeowner or other user. Another example is electricity that is switched on and off via a wall switch or light switch by a homeowner or other user. These homeowners or other users are also able to turn off the utilities in a house or business by manually throwing a main electrical switch, manually shutting a water main off, manually shutting down a gas line, etc.

It is to improvements in dealing with emergency measures for multiple utilities that embodiments of the present invention are directed.

### SUMMARY OF THE INVENTION

The present invention is directed to monitoring multiple utilities in a home or business that is useful in providing emergency shutdown of one or more of the utilities in the home or business.

Certain embodiments of the present invention can therefore comprise a utility monitoring system comprising: a first sensor in-line in a first utility; a second sensor in-line in a second utility; a server; a control hub/panel communicatively linked to the server, the first sensor and the second sensor adapted to provide sensor input to the control hub, wherein the control hub is not adapted to control the first utility or the second utility except for shutting the first utility or the second utility off based on the sensor inputs from the first sensor or the second sensor. Another embodiment contemplates the control hub communicatively linked to the server is by way of a Z-wave connection. Another embodiment contemplates the first sensor and the second sensor inputs to the control panel are by way of Z-wave connection. Another embodiment contemplates the control hub shutting the first utility or the second utility off by way of Z-wave communication. Yet another embodiment of the utility monitoring system is contemplated wherein the first utility and the second utility are selected from a group consisting of: heating, cooling, plumbing, lighting, gas. An embodiment of the utility monitoring system is contemplated further comprising an interactive database that is coupled to the server with data storage capacity wherein data acquired from the first sensor and the second sensor are retained. Another embodiment of the utility monitoring system is contemplated wherein the control hub is adapted to shut off a) the first utility when a predetermined first threshold directly associated with the first utility is reached or b) the second utility when a predetermined second threshold directly associated with the second utility is reached. Additionally, wherein the predetermined first threshold and second threshold is evaluated by the control hub and wherein the first or the second utility is shut off automatically. An embodiment of the utility monitoring system is contemplated wherein the first sensor is linked to a first on/off device that is only capable of an on state and an off state and the second sensor is linked to a second on/off device that is only capable of an on state and an off state. Additionally, wherein the control hub is linked to the first on/off device that is inline in the first utility and the second on/off device that is inline in the second utility. Additionally, wherein the first on/off device and the second on/off device is not openly accessible. Or where the first and the second on/off device is independent of openly accessible controls other than the control hub. Or where the first and the second on/off device is controlled only electrically. Or when wherein an appliance is capable of accommodating the on/off device. An embodiment of the utility monitoring system is further contemplated wherein the server is linked to a communication center. Another embodiment of the utility monitoring system is further contemplated wherein the communication center is adapted to send an alert to a home owner/end user of the utilities when either the first utility or the second utility is shut off. Yet another embodiment of the utility monitoring system is further contemplated wherein an appliance is capable of accommodating the first sensor and wherein the appliance is capable of being turned on or off via signals from the control hub.

Other embodiments of the present invention can therefore comprise a utility monitoring system comprising: a first sensor in-line in a first utility; a first on/off device electrically linked to the first sensor, the first on/off device adapted to shut off the first utility; a second sensor in-line in a second utility; a second on/off device electrically linked to the second sensor, the second on/off device adapted to shut off the second utility; a server with physical data storage capacity; and a control hub communicatively linked to the server, the first sensor, the second sensor, the first on/off device, and the second on/off device wherein the control hub is not adapted to control the first utility except for shutting the first utility off via the first on/off device based on electrical inputs from the first sensor, the control hub is not adapted to control the second utility except for shutting the second utility off via the second on/off device based on electrical inputs from the second sensor.

### BRIEF DESCRIPTION OF THE DRAWINGS

FIG. 1 illustratively depicts an embodiment of a house with a utility monitoring system consistent with embodiments of the present invention.

FIG. 2 illustratively depicts an embodiment of multiple homes or buildings connected through a utility monitoring system consistent with embodiments of the present invention.

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in optional types of buildings and utilities.

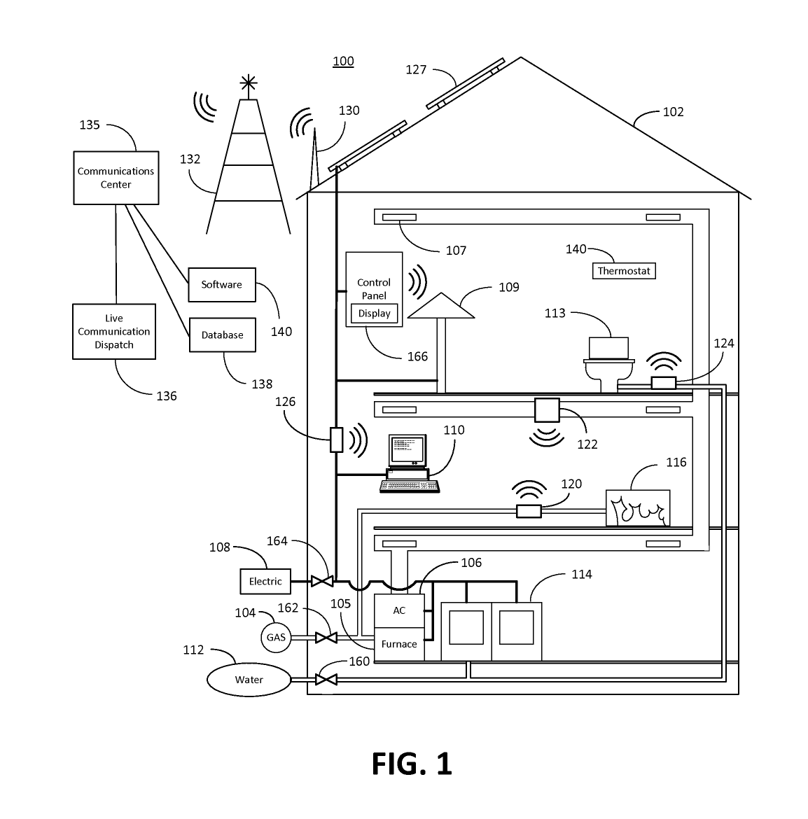

FIG. 1 is an illustration of a utility monitoring system 100 including a house 102 where embodiment of the present invention can be advantageously practiced. As depicted, a utility monitoring system 100 in the present embodiment generally includes a house 102 possessing a gas utility 104, a heating/cooling/ventilation utility 106, an electric utility 108, and water utility 112 that all have associated sensors and control switches that are all linked with a control panel 166. The sensors can be in-line with the utility, mounted on a walls, ceilings, in walls, and the like. Embodiments contemplate at least one sensor for each utility. More specifically, and by way of example, the water utility 112 possesses at least one sensor 124 that can communicate with the control panel/hub 166 and a shut-off valve 160 that is arranged and configured to turn on and off the water supply 112 to the house 102. Likewise the gas utility 104 possesses at least one gas sensor 120 that can communicate with the control panel 166 and a shut-off valve 162 that is arranged and configured to turn on and off the gas supply 104 to the house 102. Likewise, the electric utility 108 possesses at least one electrical sensor 126 that can communicate with the control panel 166 and a shut-off switch 164 that is arranged and configured to turn on and off the electric supply 108 to the house 102. The furnace and Air Conditioning (AC) utility 106 possesses at least one sensor 122 that can sense, for example heating, cooling, and flow. The furnace and AC utility 106 also possesses a shut-off switch or valve (not shown) in line with the system communicatively linked with the control panel 166. For purposes of simplicity, the term “switch” will be used interchangeably with “valve”, electrical switch”, or other devices capable of turning a utility on or off. The control panel 166 can possess a display whereby a user can interface to control the utilities 104, 105, 106, 108, and 122 for example. Certain embodiments contemplate the user being able to override settings in the control panel 166, and/or optionally manually control all on/off signals to the utilities 104, 105, 106, 108, and 122, which can take precedence over all other commands coming through the control panel 166. The control panel 166 can further be linked, via wireline or wirelessly, with an antenna 130 that can wirelessly transmit (such as by a Z-wave) the utility information from the house 102 to a communications center 135 or receive information from the communications center/server 135 directed to the control panel 166.

Generally speaking, certain embodiments of the present invention contemplate the control panel 166 being adapted to control the various utilities described in conjunction with FIG. 1. Embodiments also contemplate the control panel 166 being linked with a communications center 135 that can monitor the utilities in the house 102. In the embodiment shown, a house antenna 130 transmits utility information, and potentially other information, to a radio tower 132, which then transmits the utility information to the communications center 135. Though, communication is depicted to the communications center 135 via a relay tower 132, certainly embodiments are contemplated wherein the control panel 166 is directly transmitting to the communications center 135, or via many relays some of which may be a combination of wireless and wireline, without departing from the scope and spirit of the invention. Moreover, though the antennae is depicted on the house 102, such functionality can be incorporated in the control panel 166, for example. Certain embodiments envision the communications center 135 possessing a database 138 capable of retaining data generated by the various utilities. Additional embodiments contemplate appropriate software 140 and computing systems to monitor the house 102 (e.g. via data acquisition techniques), provide actions if preset limits associated with the utilities are triggered, and provide instructions to the control panel 166, just to name certain computing features of the communications center 135. The control panel 166 receiving instructions from the communications center 135 to turn on or off the utility, or multiple utilities, based on a trend of data acquired from one or more sensors, or specific signals transmitted from the sensors. Yet other embodiments contemplate a live communications dispatch 136 communicatively linked with the communications center 135 that can field calls with homeowners and/or authorities should a problem be transmitted by the control panel 166.

The control panel 166 can be set to trigger turning a utility on and off based on utility limits set by a user or client in communication with the control panel 166. For example, a user or client can set an off limit if a utility consumes a maximum allowed consumption, maximum amount of money spent in a certain time frame, natural events, i.e., fire, carbon monoxide levels in the house 102, minimum house temperatures (temperatures reaching or nearing freezing), maximum house temperatures, earthquakes, flooding, massive damage to the house 102, etc. An example of setting a limit of maximum allowed consumption is envisioned to include, for example a maximum amount of water used in a time period (such as number of gallons in a month), or a maximum amount of gas used over a period of time, or a maximum number of Watts consumed in a time period, etc. An example of maximum amount of money spent in a certain time frame can include setting a shut off limit to a utility when the cost of a utility over a certain period of time reaches a budgeted amount of money to be spent on that utility, e.g., shut the electricity off when power use reaches a cost of $250.00 within one month. Embodiments further contemplate a sending a notice to a user, such as via a smart phone or computer when a utility consumption approaches a maximum allowed consumption or cost. For example, sent a notice at 75%, 80%, 85%, etc. of maximum allowed consumption or cost of a utility. With consideration of specifically the electrical utility 108 of FIG. 1, the present embodiment depicts an electrical source 108 connected to the house 102 wherein there is conductively connected to the AC unit 106, the furnace 105, a washer and dryer 114, a computer 110, a lamp 109, solar panels 127 (such as photo-voltaic), and the control panel 166. As illustratively shown, there is at least one sensor 126 in-line with the electrical system and at least one on/off switch 164 that is capable of cutting power to the whole house 102 or optionally portions of the house 102. Other embodiments envision many sensors, perhaps tied into the different circuits in the house 102, or to different devices, or to individual devices, just to name several examples. Certain embodiments contemplate the on/off switch 164 not being easily accessed by a homeowner, such as in a cabinet in a wall, attic, or subfloor, for example, in the house 102. Certain embodiments contemplate the on/off switch 164 being tied into the main electrical switch to the house 102. Certain embodiments contemplate the at least one sensor 126 being essentially inaccessible by a homeowner such as being buried in a wall, in an electrical box sunken into a wall (perhaps with a screwed on cover), tied in with a fuse box, etc. In this way, the on/off device is not openly accessible and are not viewably disposed on a wall in a living environment (in the kitchen, bathroom, living room, etc.) of the house 102. The electrical sensor 126 can be linked with the control panel 166 via wireline or wirelessly. One embodiment contemplates wireless communication with the control panel by way of Z-Wave or similar transmissions. Certain embodiments contemplate a homeowner controlling individual electrical components within the house 102 by way of the control panel 166 (such as through the display and user interface, e.g., a touch pad, PC, or other similar computing device) or via a user-device that is in communication with the control panel 166, such as a personal computer, tablet, or cell phone, for example. Some embodiments contemplate the control panel 166 communicatively linked with a communications center 135 that is capable of linking with a plurality of houses and other buildings. Some embodiments of the communications center 135 envision a database 138 with acquired electrical utility data in the house 102. Some embodiments contemplate the communications center 135 possessing the ability to turn on and off the electric utility or components tied to the electrical system within the house 102. Yet other embodiments contemplate the communications center 135 tied to a live communication dispatch 136 that can alert a home owner of a problem with their electrical utility 108 that is received by the communications center 135. The communications center, in certain embodiments, possesses the appropriate software 140 that channels communication, sets electrical consumption or surge limits that trigger a response either to a live communication dispatch 136 or sending controlling instructions to turn power on and off in the house 102.

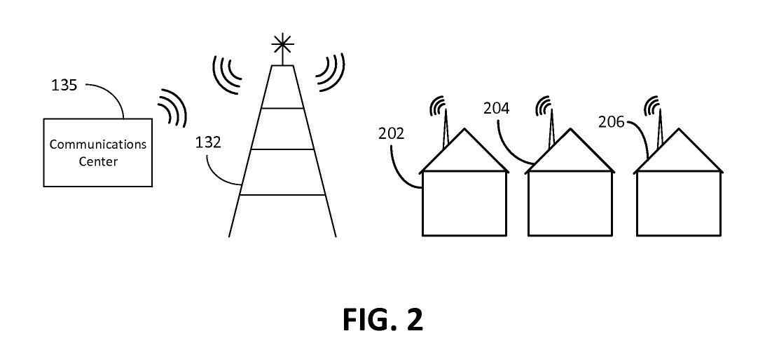

With reference to FIG. 2, depicted is an illustration of a communication center communicatively linked with a plurality of utility using buildings/structures, such as homes 202, 204, and 206 consistent with embodiments of the present invention. Certain embodiments contemplate one or more control panels 166 (from one or more homes or businesses) communicatively linked between multiple structures such as homes or businesses and at least one communication center 135. The communications center 135, as envisioned in certain embodiments, may have reason to shut a utility off (or turn on) on all of the homes or businesses, or some of the homes or businesses, or combination thereof. In this way, the communications center 135 will instruct each home or business or combination thereof to shut off one or more particular utilities, such as by sending on/off commands to the control panels 166. The control panels 166 will then execute the shut off (or turn on) instructions/commands from the communications center 135. The shutoff valves and shutoff switches are not a single switch or valve for region, but rather within each of the homes and businesses. Hence, the communications center 135, or some equivalent thereof, can control shutting off (or turning on) a region (or part of a region) including homes and/or businesses by shutting off each home and/or business independently of one another (e.g., one at a time). With consideration of specifically the gas utility 104 of FIG. 1, in addition to the electrical utility 108 described above, the present embodiment also depicts a gas source 104 supplying gas to the house 102, though typically natural gas and/or propane, not limited thereto. Gas 104 is illustratively shown providing pipelines to the furnace 105 and the fireplace 116. As exemplified, there is at least one gas sensor 120 in-line with the gas line and at least one gas on/off valve 162 that is capable of cutting off gas 104 to the whole house 102 or optionally portions of the house 102. Other embodiments envision many sensors, perhaps tied into the different devices connected to the gas line. Certain embodiments contemplate the gas on/off valve 162 not being easily accessed by a homeowner, such as in a cabinet in a wall in the house 102. The gas on/off valve 162 is contemplated to be electrically actuated to turn on and off. Certain embodiments contemplate the gas on/off valve 162 being tied into the main gas line to the house 102. Certain embodiments contemplate the at least one gas sensor 120 being essentially inaccessible by a homeowner such as being buried in a wall, in an gas box sunken into a wall (perhaps with a screwed on cover), etc. The gas sensor 120 can be linked with the control panel 166 via wireline or wirelessly. One embodiment contemplates wireless communication with the control panel by way of Z-Wave transmissions. Certain embodiments contemplate a homeowner controlling individual gas components within the house 102 by way of the control panel 166 (such as through the display and user interface, e.g., a touch pad) or via a user-device that is in communication with the control panel 166, such as a personal computer, tablet, or cell phone, for example. Some embodiments contemplate the control panel 166 communicatively linked with a communications center 135 that is capable of linking with a plurality of houses and other buildings. Some embodiments of the communications center 135 envision a database 138 with acquired gas utility data in the house 102. Some embodiments contemplate the communications center 135 possessing the ability to turn on and off the gas utility 104 or components tied to the gas utility 104 within the house 102. Yet other embodiments contemplate the communications center 135 tied to a live communication dispatch 136 that can alert a home owner of a problem with their gas utility 104 that is received by the communications center 135. The communications center, in certain embodiments, possesses the appropriate software 140 and switches that channels communication, sets gas pressure or gas use limits that trigger a response either to a live communication dispatch 136 or sending controlling instructions to turn on and off the gas to the house 102.

With consideration of specifically the water utility 112 of FIG. 1, in addition to the electrical utility 108 and the gas utility 104 described above, the present embodiment also depicts a water source 112 supplying water to the house 102. Water 104 is illustratively shown providing waterlines to the washing machine 114 and toilette 113 (and solar panels 127 if they are thermal solar panels). As exemplified, there is at least one water sensor 124 in-line with the waterline and at least one water on/off valve 160 that is capable of cutting off water 112 to the whole house 102 or optionally portions of the house 102. Other embodiments envision many water sensors, perhaps tied into the different components (sinks, toilets, sprinkler systems, sewage, etc.) connected to the waterline. Certain embodiments contemplate the water on/off valve 160 not being easily accessed by a homeowner, such as in a cabinet in a wall in the house 102. The water on/off valve 160 is contemplated to be electrically actuated to turn on and off. Certain embodiments contemplate the water on/off valve 160 being tied into the main waterline to the house 102. Other embodiments contemplate the main waterline being cut off in the house 102. Certain embodiments contemplate the at least one water sensor 124 being essentially inaccessible by a homeowner such as being buried in a wall, in an water box sunken into a wall (perhaps with a screwed on cover), etc. The water sensor 124 can be linked with the control panel 166 via wireline or wirelessly. One embodiment contemplates wireless communication with the control panel by way of Z-Wave transmissions. Certain embodiments contemplate a homeowner controlling individual water components within the house 102 by way of the control panel 166 (such as through the display and user interface, e.g., a touch pad) or via a user-device that is in communication with the control panel 166, such as a personal computer, tablet, or cell phone, for example. Some embodiments contemplate the control panel 166 communicatively linked with a communications center 135 that is capable of linking with a plurality of houses and other buildings. Some embodiments of the communications center 135 envision a database 138 with acquired water utility data in the house 102. Some embodiments contemplate the communications center 135 possessing the ability to turn on and off the water utility 104 or components tied to the water utility 104 within the house 102. Yet other embodiments contemplate the communications center 135 tied to a live communication dispatch 136 that can alert a home owner of a problem with their water utility 104 that is received by the communications center 135. The communications center, in certain embodiments, possesses the appropriate software 140 that channels communication, sets water pressure or water use limits that trigger a response either to a live communication dispatch 136 or sending controlling instructions to turn on and off the water to the house 102.

With consideration of specifically the heating and cooling utility 105 and 106 of FIG. 1, in addition to the electrical utility 108, the gas utility 104, and the water utility 112 described above, the present embodiment also depicts a furnace 105 and AC unit 106 supplying heating and cooling to the house 102 via the ducts 107. Some homes and structures have a different arrangement for delivering heat and possibly cooling. Accordingly, different arrangements for heating and possibly cooling are generally translated within the scope and spirit of the present invention via a skilled artisan after having possession of the present disclosure. The furnace 105 and AC 106 are illustratively shown providing heating and cooling to the rooms in the house 102 via the ducts 107. As exemplified, there is at least one heating and cooling sensor 122 in-line with the ducts 107 and at least one thermostat 140 and at least one on/off switch (not shown) either at the AC 106 or furnace 105 or the gas on/off valve 162 and/or the electric on/off switch 164 that is capable of stopping operation of the AC unit 106 or the furnace 105. Optionally, valves in the ducts 107 can shut off heat and AC to portions of the house 102. Other embodiments envision many heating and cooling sensors, perhaps tied into different duct lines and/or rooms, for example. Certain embodiments contemplate the heating and cooling on/off switches not being easily accessed by a homeowner, such as switches in a cabinet in a wall in the house 102. Switches that are easily accessed by the homeowner include thermostats and other switching devices typically mounted on a wall. The heating and cooling on/off switches are contemplated to be electrically actuated to turn on and off. Certain embodiments contemplate the at least one heating and cooling sensor 122 being essentially inaccessible by a homeowner such as being buried in a wall, in an box sunken into a wall (perhaps with a screwed on cover), in a panel accessing the ducts, etc. The at least one heating and cooling sensor 122 can be linked with the control panel 166 via wireline or wirelessly. One embodiment contemplates wireless communication with the control panel by way of Z-Wave transmissions. Certain embodiments contemplate a homeowner controlling individual heating and cooling components within the house 102 by way of the control panel 166 (such as through the display and user interface, e.g., a touch pad) or via a user-device that is in communication with the control panel 166, such as a personal computer, tablet, or cell phone, for example. Some embodiments contemplate the control panel 166 communicatively linked with a communications center 135 that is capable of linking with a plurality of houses and other buildings. Some embodiments of the communications center 135 envision a database 138 with acquired heating and cooling utility data from the house 102. Some embodiments contemplate the communications center 135 possessing the ability to turn on and off the furnace 105, the AC unit 106, or the electricity or gas supplying the utilities within the house 102. Yet other embodiments contemplate the communications center 135 tied to a live communication dispatch 136 that can alert a home owner of a problem with their heating 105 and or cooling 106 utility that is received by the communications center 135. The communications center, in certain embodiments, possesses the appropriate software 140 that channels communication, sets heating and cooling limits that trigger a response either to a live communication dispatch 136 or sending controlling instructions to turn on and off the heating 105 and or cooling 106 utility to the house 102.

Embodiments contemplate the communication center 135 receiving and acquiring a variety of utility data from a plurality of homes and businesses, for example, and retaining the data in the database 138. Embodiments contemplate using the utility data from the plurality of homes and businesses to provide insight into early component failure or poor utility performance by comparing utility usage of the plurality of homes or businesses. Such information, for example, is envisioned to alert a homeowner that a furnace (or other utility) is failing or needs a repair based on a) previous performance of that furnace in the home or business, or b) performance of furnaces in like homes or businesses in the same geographical region. It is further envisioned that other devices, such as locks, fire alarms, smoke detectors, carbon monoxide detectors, etc., be received by the communications center 135 and processed with alert calls to a home owner or sent to a live communications dispatch, for example, as with the utilities.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms used herein. For example, the Z-Wave wireless communication is well known in the art and can be interchanged with other wireless communications while still maintaining substantially the same functionality without departing from the scope and spirit of the present invention. In another example, the utilities described are by example and others can be introduced without departing from the scope and spirit of the present invention. Also, the arrangement of the utilities, sensors, shutoff valves and switches described herein by way of example and not limitation. The preferred embodiments described herein are directed to monitoring and controlling multiple utilities, which in some embodiments is a binary state—on and off, but in other embodiments may not be so limited.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed and as defined in the appended claims.

What is claimed is:

1. A monitoring system comprising:
a first sensor in-line in a first utility in a structure;
a second sensor in-line in a second utility in said structure;
a server;
a control hub communicatively linked to said server, said first sensor and said second sensor, wherein said control hub is not adapted to control said first utility or said second utility except for shutting said first utility or said second utility off based on electrical inputs from said first sensor and said second sensor.

2. The monitoring system of claim 1 wherein said first utility and said second utility are selected from a group consisting of: heating, cooling, plumbing, lighting, or gas.

3. The monitoring system of claim 1 further comprising an interactive database that is coupled to said server having data storage capacity wherein data acquired from said first sensor and said second sensor are retained.

4. The monitoring system of claim 1 wherein said control hub is adapted to shut off a) said first utility when a predetermined first threshold directly associated with said first utility is reached or b) said second utility when a predetermined second threshold directly associated with said second utility is reached.

5. The monitoring system of claim 4 wherein said predetermined first threshold and second threshold is evaluated by said control hub and wherein said first or said second utility is shut off automatically.

6. The monitoring system of claim 1 wherein said first sensor is linked to a first on/off device that is only capable of an on state and an off state and said second sensor is linked to a second on/off device that is only capable of an on state and an off state.

7. The monitoring system of claim 6 wherein said control hub is linked to said first on/off device that is inline in said first utility and said second on/off device that is inline in said second utility.

8. The monitoring system of claim 7 wherein said first on/off device and said second on/off device is not openly accessible in said structure.

9. The monitoring system of claim 6 wherein said first and said second on/off device is independent of openly accessible controls other than said control hub.

10. The monitoring system of claim 6 wherein said first and said second on/off device is controlled only electrically.

11. The monitoring system of claim 1 wherein said server is linked to a communication center.

12. The monitoring system of claim 1 wherein said communication center is adapted to send an alert to an owner of said utilities when either said first utility or said second utility is shut off.

13. The monitoring system of claim 1 wherein an appliance is capable of accommodating said first sensor.

14. A utility monitoring system for a building comprising:
a first sensor in-line with a first utility comprised by said building;
a first on/off device electrically linked to said first sensor, said first on/off device adapted to shut off said first utility;
a second sensor in-line with a second utility comprised by said building;
a second on/off device electrically linked to said second sensor, said second on/off device adapted to shut off said second utility;
a server with physical data storage capacity connected to said first sensor, said first utility, said second sensor and said second utility;
a control hub communicatively linked to said server, said first sensor, said second sensor, said first on/off device, and said second on/off device wherein said control hub is incapable of controlling said first utility except for shutting said first utility off via said first on/off device based on electrical inputs from said first sensor, said control hub is incapable of controlling said second utility except for shutting said second utility off via said second on/off device based on electrical inputs from said second sensor.

15. The utility monitoring system of claim 14 wherein said first and said second sensors are not viewably disposed in a living environment of said building.

16. The utility monitoring system of claim 14 wherein said server is linked to a communication center, said communication center adapted to notify an owner of said building only if one of said on/off devices is turned off.

17. The utility monitoring system of claim 14 wherein said sensors are inside of said building.

18. The utility monitoring system of claim 14 wherein a central communication center that is linked to multiple control panels disposed in multiple buildings, the central communication center adapted to turn off one of said utilities in all of the buildings via each of the multiple control panels.

19. The utility monitoring system of claim 14 further comprising a third sensor in-line with a third utility comprised by a second building, a third on/off device electrically linked to said third sensor, said third on/off device consisting of turning on or off said third utility, said control hub communicatively linked to a second server connected to said third on/off device and said third sensor, said control have incapable of controlling said third utility except for shutting off said third utility via said third on/off device based on electrical inputs from said third sensor.

20. A utility monitoring system for a plurality of buildings comprising:
a first sensor in-line with a first utility disposed in a first building of said plurality of buildings;
a second sensor in-line with a second utility disposed in said first building;
a third sensor in-line with a third utility disposed in a second building of said plurality of buildings;
a first switch consisting of on/off states electrically linked to said first sensor, a second switch consisting of on/off states electrically linked to said second sensor, a third switch consisting of on/off states electrically linked to said third sensor, said first and said second on/off switches located in said first building, said third on/off switch located in said second building;
a first control hub, comprised by said first building, linked with said first and said second sensors and said first and said second on/off switches;
a second control hub, comprised by said second building, linked with said third sensor and said third on off switch; and
a communications server with physical data storage capacity communicatively linked to said first control hub and said second control hub, said first and said control hubs adapted to execute on/off commands received from said communications server.
